(19) United States
(12) Patent Application Publication
(10) Pub. No.: US 2006/0107227 A1
(43) Pub. Date: May 18, 2006

(54) Device with a graphical user interface

(76) Inventor: Harri Kiljander, Espoo (FI)

Correspondence Address: MORGAN & FINNEGAN, L.L.P., 3 WORLD FINANCIAL CENTER, NEW YORK, NY, 10281-2101, US

(21) Appl. No.: 10/534,670

(22) PCT Filed: Nov. 14, 2002
(86) PCT No.: PCT/EP02/12739

§ 371 Date: Oct. 19, 2005

(51) Int. Cl. G06F 17/00

(52) U.S. Cl. 715/772; 715/810

(57) ABSTRACT

A device (8), such as a multitasking mobile telephone or personal digital assistant (PDA), comprises a processor (15) and a user interface including keys (10, 11) and a display (12). In response to a request from a user to view a menu, the processor (15) compiles a list of menu options and determines the status of applications or functions associated with the menu options. If the menu option relates to an active application, an indicator is added to the list of menu options. The menu is displayed with the active or inactive status of the applications represented using animated icons (26a-c), color of text (25a-c) and/or icons (28a-c), sound, vibration or a combination of two or more of these properties. These properties may also be used to indicate the type of task being performed by an application.

### FIELD OF THE INVENTION

The invention relates to a device with a graphical user interface. In particular, the invention relates to a method for compiling a menu in such a device and is particularly suitable for use in a multitasking environment.

### BACKGROUND

Devices such as mobile telephones or personal digital assistants (PDAs) are commonly provided with graphical user interfaces (GUIs), in which a user is presented with one or more menus listing available functions or applications. Examples of conventional user interfaces are shown in FIGS. 1a and 1b. The menu options may be presented to the user on a display 1, in the form of a list of icons 2 and/or text labels 3, as in FIG. 1a, where one or more options are shown simultaneously. This type of menu is often employed in mobile telephones. The user can scroll through the list by moving a focus window 4 over the various options, using a keypad. Where the display 1 does not show all the available menu options, e.g. due to limitations in its size, the interface may include a bar 5 that indicates the position of the menu options currently displayed within the full list of menu options.

Alternatively, the menu options may be shown on a display 6 as a two dimensional matrix with text 3 and/or suitable icons 2, as in FIG. 1b. The user may select an option using a focus window or a stylus. Menus in PDAs are commonly presented in this manner. The menu may include a scroll bar 7 in order to allow the user to view any menu options that are not shown on the display 6.

Both types of menu may use animated icons. In devices with a colour display 1, 6, the icons may be in colour. Further examples of prior user interfaces are shown in US2002/0041292 A1.

However, these menus provide the user with only a limited amount of information about the menu options, especially in devices, such as mobile telephones, where the size of the display window 1, 6 is small. For example, a user may have activated an application to divert all incoming calls to another telephone number. The menu itself would not provide any indication as to whether or not the call divert function is in operation. In order to obtain status information about an application, the user may be required to navigate through a number of menus and associated sub-menus. This procedure is inefficient and undesirable in devices that do not include sophisticated keypads, such as mobile telephones.

These drawbacks will increase in importance as the provision of multitasking capabilities in such devices becomes more widespread. Where a device is capable of performing a number of applications simultaneously, a user may not be aware of which applications or functions are active at a particular time. A user could inadvertently leave a number of applications open, which, in a device with limited memory facilities, would lead to inefficient operation.

### SUMMARY OF THE INVENTION

According to the invention, a device comprises a user interface and a processor configured to receive a request for access to a menu from a user, compile a list of menu options, determine whether an application associated with a menu option is active or inactive and associate a corresponding status indicator with the menu option and display the list of menu options, where the presentation of a particular menu option is dependent on its associated status indicator.

The device may be a hand-held telecommunications device, personal digital assistant or personal computer and may have multitasking capability.

The invention further provides a method of operating such a device and a computer program for configuring a device to perform the method.

The active and inactive indicators associated with a particular application may be icons or text labels which differ in terms of their animation or colour. Alternatively, the indicators may be use sound or vibration to convey the application status, or a combination of two or more of animation, colour, sound or vibration.

The invention increases the amount of information provided in a menu-type display by including information relating to the status of an application. This reduces the amount of navigation performed by a user in order to ascertain whether or not an application is currently active. The device may be configured to include more detailed information in a menu, such as the type of task being performed by the application and/or the proportion of the task that has been completed, in addition to its status.

The invention facilitates efficient memory handling, particularly with respect to multitasking devices as, when a user is selecting an application or menu option, they will be aware of the applications that are running, have been interrupted or are incomplete. This information can be used in order to free up memory resources by ending redundant applications.

The invention can be implemented using the resources already present in conventional devices. For example, sound generation and vibration means are provided in many mobile telephones in order to alert the user to incoming calls and messages, while many mobile telephones or PDAs are provided with animation engines and/or colour display facilities.

### BRIEF DESCRIPTION OF THE DRAWINGS

Embodiments of the invention will now be described with reference to the accompanying drawings, in which:

FIGS. 1a and 1b show conventional graphical user interfaces;

FIG. 2 shows a mobile telecommunications device in which the invention may be implemented;

FIG. 3 is a block diagram of the components of the mobile telecommunications device of FIG. 2;

FIG. 4 is a flowchart showing a process for compiling and displaying a menu according to an embodiment of the invention;

FIGS. 5 and 6 show graphical user interfaces according to embodiments of the invention;

FIG. 7 is a flowchart showing an alternative process for compiling and displaying a menu according to a further embodiment of the invention;

FIG. 8 is a flowchart showing an alternative process for displaying a menu according to a further embodiment of the present invention.

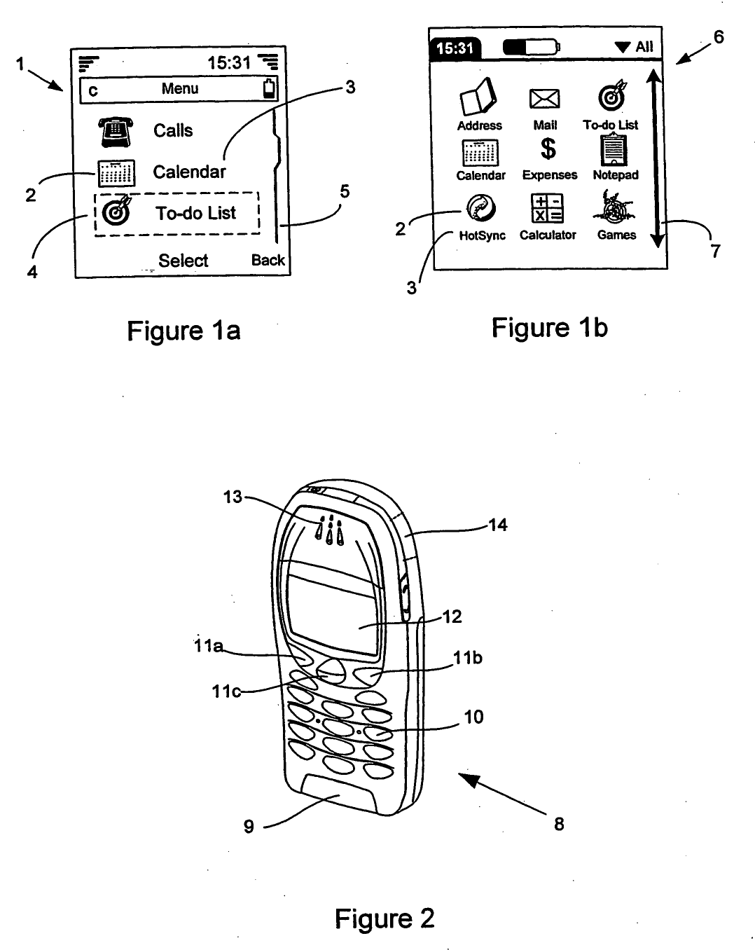

### DETAILED DESCRIPTION

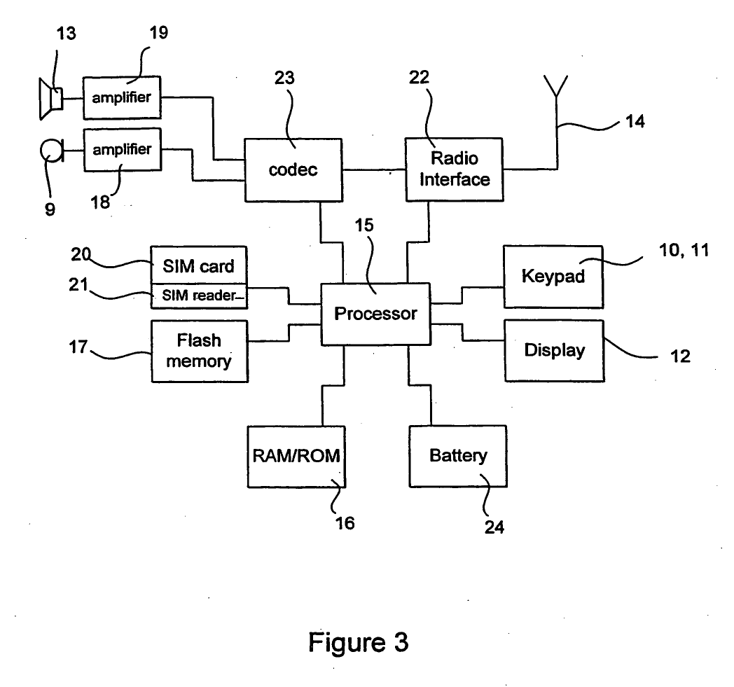

FIG. 2 depicts a mobile telecommunications device 8, which comprises a microphone 9, keypad 10, softkeys 11, display 12, speaker 13 and internal antenna 14. The components of the device 8 are shown in more detail in FIG. 3. A processor 15 controls signal processing and user interface functions and has associated memory facilities in the form of a RAM/ROM 16 and flash memory 17. Electrical analogue audio signals are produced by the microphone 7 and amplified by a pre-amplifier 18. Similarly, analogue audio signals are fed to the speaker 13 through an amplifier 19. The processor 15 receives instruction signals from the keypad 10 and soft keys 11a, 11b, 11c and controls operation of the display 12 and flash memory 17.

Information concerning the identity of the user is held on a smart card 20 in the form of a Subscriber Identity Module (SIM) card, which contains the usual GSM international mobile subscriber identity and encryption that is used for encoding the radio transmission in a well known manner. The SIM card 20 is received in a SIM card holder 21. Radio signals are transmitted and received by means of the antenna 14 connected through a r.f. stage 22 to a codec 23 configured to process signals under the control of the processor 15.

When a user wishes to access an application, they select a relevant menu option from a main menu and optionally one or more sub-menus. For example, a main menu includes menu options for displaying stored telephone numbers, making a telephone call accessing the internet or voicemail, displaying a task list or calendar, setting up a call divert function, reading Short Message Service (SMS) messages, setting alarms or playing games etc. Selecting an option relating to internet access may lead to a sub-menu with options to navigate to bookmarked pages, enter a URL or to return to the main menu. A call divert sub-menu may include options to set up a call divert function and to cancel an active call divert function.

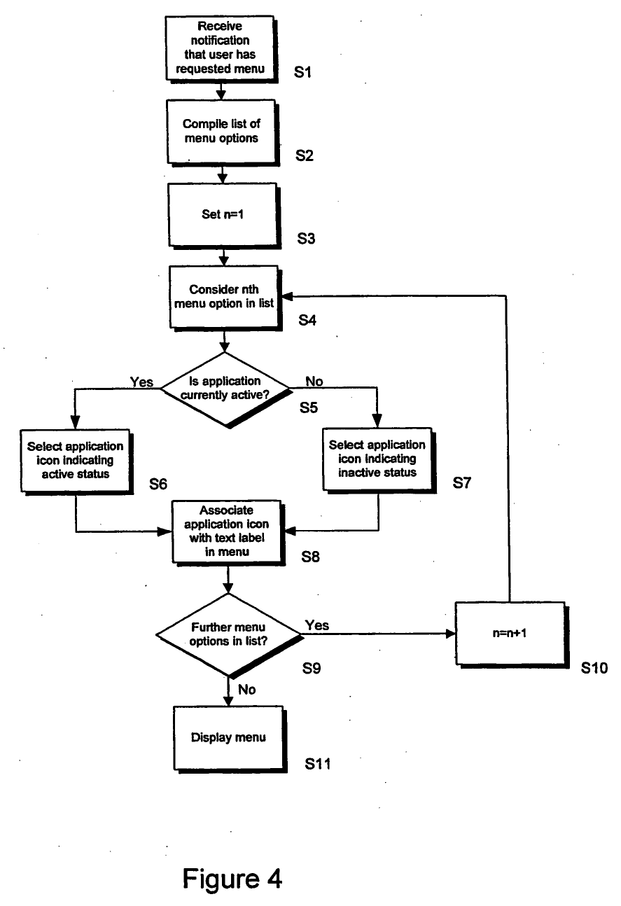

The user requests a menu using the keypad 10 and softkeys 11 as necessary. Referring to FIG. 4, the processor 15 receives notification that the user has elected to view a menu (step s1). The processor 15 compiles a list of the menu options comprising the relevant available applications (step s2). In this example, the user requests the main menu.

The processor then considers the first menu option in the list (steps s3, s4) and determines whether or not it relates to an active application (step s5), i.e. an application that is running, is incomplete or has been interrupted. In this embodiment, the application is associated with a text label and two icons. The two icons are used to indicate the status of the application and differ in their properties, e.g. one icon may be animated while the other is static or the active and inactive icons may be animated using different animation sequences or colour schemes. For example, an active application may be indicated using a three-dimensional animation, i.e. with an icon representing a three dimensional object that can turn or rotate, while an inactive application may be denoted by a two-dimensional animation. If the application is active, the processor 15 selects the icon that indicates that the application is active (step s6), e.g. the animated icon, while, if the application is inactive, the processor selects the other of the two icons (step s7), e.g. the static icon. The processor 15 then associates the appropriate icon with the text label for inclusion in the menu (step s8).

If there are further menu options in the list (step s9), the processor 15 moves onto the next menu option (step s10) and repeats this process (steps 4-9) for each remaining menu option in the list. The menu is then displayed (step s11) with the menu options presented in the form of a list or matrix, each application being represented by a text label and an icon. In this manner, the menu provides a user with status information for the applications associated with the menu options, without requiring the user to navigate through further screens.

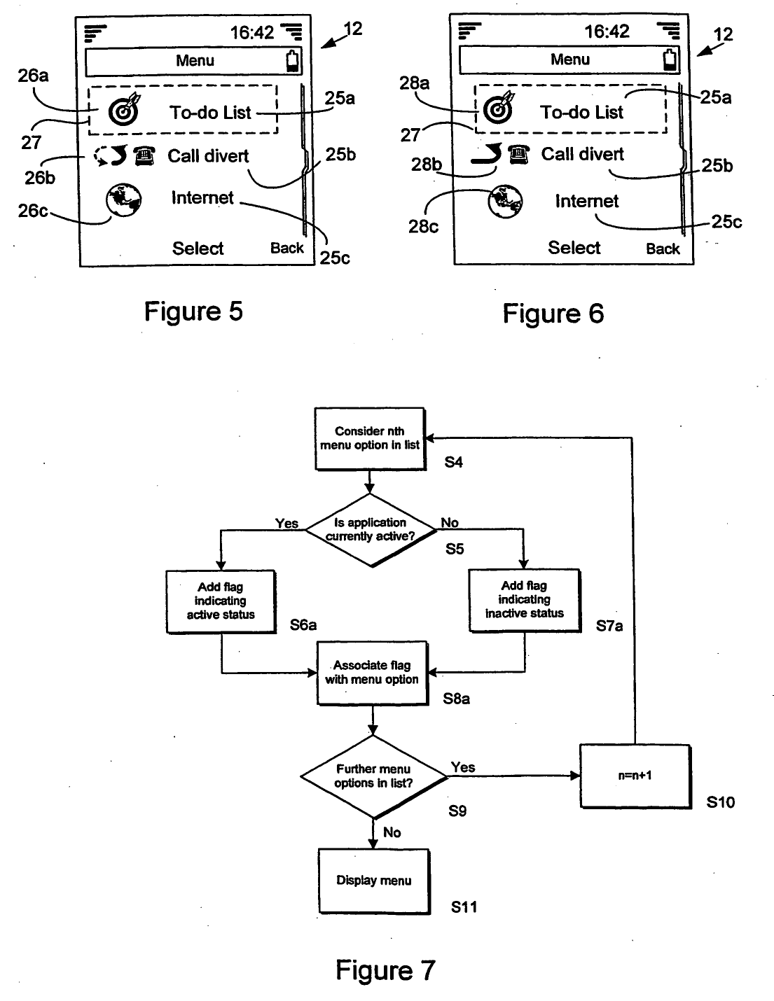

FIGS. 5 and 6 show examples of menus comprising text labels 25a, 25b, 25c, identifying available applications and associated icons 26a, 26b, 26c, 28a, 28b, 28c, selected on the basis of application status as compiled by the process of FIG. 4. For example, the menus contain a “call divert” option for forwarding incoming calls to the device 8 to another telephone, device or voicemail service and an “internet” option for accessing the Internet using a Wireless Application Protocol (WAP) function. The user is presented with a menu on display 12 in which the call divert function is currently active, but the WAP application is inactive. In FIG. 5, this is indicated by the call divert icon 26b being animated, as represented by the dotted line, while the games icon 26c is static. For example, a static icon indicating inactive status may be formed from a frame in the animation sequence of an animated icon used to represent an active application status. However the animation may take the form of simple flashing of the icon 26b, or, for a given application, both the active and static icons may be animated but distinguished by different animation sequences or, where the display 12 is a colour display, using colour. The user may then select a function or application by positioning a focus window 27 over the appropriate option.

Animation engines are commonly included in mobile telecommunications devices 8. Therefore, the use of animated icons to distinguish between active and inactive applications in such a device does not require the provision of specialised resources. An existing device 8 can therefore be configured to enact the menu compilation and display procedure (steps s1-s11) using program instructions transmitted to the device using the Over The Air (OTA) mechanism for data transfer.

In the menu of FIG. 6, the status of the applications is shown by the colours of the icons 28a, 28b, 28c. An active call divert function is indicated by a black icon 28b, while the inactive WAP application is represented by a grey icon 28c. Where the display 12 is a colour display, other colours may be used to distinguish active and inactive applications, where one icon is generated from the other using a simple image filter. For example, an active application may be shown using a coloured icon, while an inactive application may be represented by a black and white, or greyscale icon. The colour of the text labels may also be manipulated in this manner.

In the menus of FIGS. 5 and 6, the status of each one of a plurality of applications is presented on the display 12 simultaneously. However, the invention may be implemented so that the status of only one application is indicated at any one instant, either by presenting the menu so that only one menu option, and therefore one application status, is shown the display 12 at a time. Alternatively, in an embodiment where a plurality of menu options is presented on the display 12, the user interface may be configured so that the status of only one application is shown at a time. This allows the use of sound and/or vibration as well as, or instead of, visual indicators, where the indication of multiple statuses simultaneously may be confusing to the user.

In a second embodiment, a procedure for compiling such a menu includes the steps of receiving a request for the menu (step s1), compiling a list of menu options (step s2) and ascertaining whether an application associated with a first menu option is currently active (steps s3 to s5) as shown in FIG. 4. Referring now to FIG. 7, the procedure continues as follows. If the application is active, a flag is added to the list of menu options to indicate this status (step s6a), e.g. by setting the value of an attribute accordingly. If the application is inactive, a flag indicating this is added to the list of menu options (step s7a) or, alternatively, step s7a is omitted, no action is taken and the absence of an active flag is used to convey an inactive status.

The flag, or attribute, is then associated with the menu option (step s8a). This process is repeated for any further menu options (steps s9, s10) and the menu is displayed (step s11).

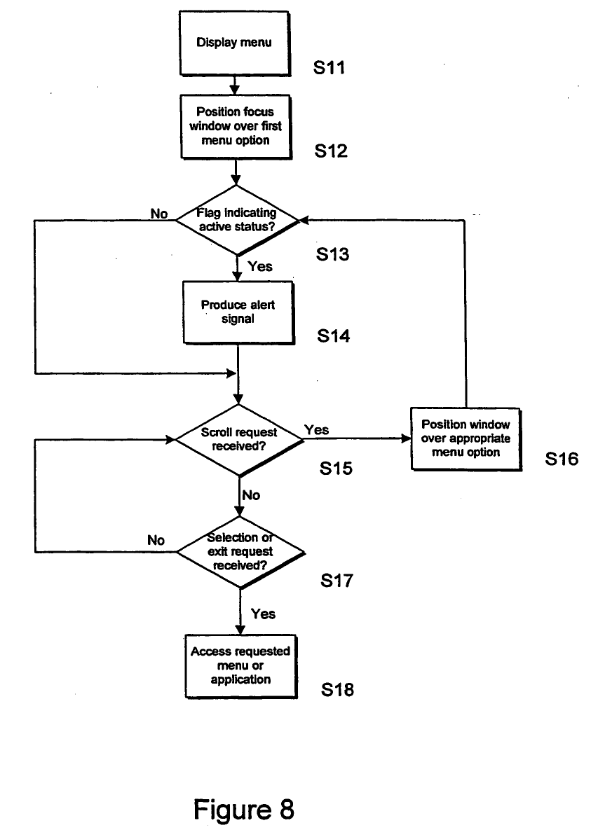

Referring now to FIG. 8, when the menu is displayed (step S11), a focus window 27 is provided so that the user can then navigate through the list and select an option. In its initial state, the focus window 27 is positioned over the first menu option (step s12). If the menu option has a flag indicating an active status (step s13), an alert signal is produced (step s14). The alert signal may be in the form of a sound, or “ear-con”, such as a buzzer or a melody, or a vibration. An audio alert signal may be selected according to the application, for example, an active notepad application may be indicated by the sound of a typewriter, while an active game may be represented by a zap or swoosh type sound.

Alternatively, the alert may take the form of animating a static icon or changing its colour, or a combination of two or more of these alert signals. If the user scrolls through the list using the keypad 20 and/or softkeys 11a, 11b, 11c (step s15), the focus window 27 is repositioned over another menu option (step s16) and the steps of determining whether the application associated with the menu option is active and, if necessary, producing an alert (steps s13, s14) is repeated. If, instead, the user selects an option or exits the menu (step s17), the appropriate action is taken (step s18).

Both sound and vibration alerts can be implemented using resources already present in mobile telecommunication devices 8 for providing sound and/or vibrating ring tones and so, again, a device 8 may be configured to perform these procedures using the OTA data transfer mechanism.

The invention has been described by way of example and is not limited to the embodiments described above. For example, the menus produced by the graphical user interface may be presented as lists or matrices. Further icons, alert signals or combinations thereof may be used to allow a user to differentiate between active, interrupted or incomplete applications waiting for user input, or between functions being performed by an application. For example, different animated icons could be used to indicate the transmission or a request and the retrieval of data in a GPRS application. The icons and alerts may also be manipulated in order to represent the progress of an application, such as a percentage of data backed up in a back up application. This could be shown, for example, by changing the colour properties of an icon, or parts of an icon, in accordance with the progress of the task. In addition to indicating application status, further icons could be configured in a similar manner to produce other alert signals, e.g. for indicating the presence of unread mail, SMS messages or new voicemail, in order to allow the use of compatible alert signals for the various applications provided in device 8.

In addition, while the embodiments have been described in relation to a hand-held mobile telecommunications device 8, the invention may be implemented in PDAs, personal computers and similar devices with menu-type interfaces.

1. A device comprising a user interface and a processor configured to:
receive a request for access to a menu from a user;
compile a list of menu options;
determine whether an application associated with a menu option is active or inactive and associate a corresponding status indicator with the menu option; and
display the list of menu options, where the presentation of a particular menu option is dependent on its associated status indicator.

2. A device according to claim 1, wherein a plurality of menu options are presented according to their corresponding status indicators simultaneously.

3. A device according to claim 1, wherein the display further comprises a focus window and the menu option corresponding to the position of the focus window is presented according to its associated status indicator.

4. A device according to claim 1, 2 or 3, wherein the status indicator is an icon and is displayed in the list of menu options.

5. A device according to claim 4, wherein the application status is indicated by the animation of the icon.

6. A device according to claim 4, wherein the application status is indicated by the color properties of the icon.

7. A device according to claim 3, configured to produce an alert where a menu option corresponding to the position of the focus window is associated with an active status indicator.

8. A device according to claim 7, wherein an alert is produced using one or more of the following: animation of an icon, color, sound or vibration.

9. A device according to claim 1, wherein the user interface comprises a display and a keypad.

10. A device according to claim 1, further configured to allow multitasking of applications.

11. A handheld telecommunications device according to claim 1.

12. A personal digital assistant device according claim 1.

13. A personal computer device according to claim 1.

14. A method of operating a device according to claim 1, comprising:
receiving a request for access to a menu from a user;
compiling a list of menu options;
determining whether an application associated with a menu option is active or inactive and associating a corresponding status indicator with the menu option; and
displaying the list of menu options wherein the presentation of a particular menu option is dependent on its associated status indicator.

15. A computer program comprising program instructions for causing a device to perform the method of claim 14.

16. A computer program according to claim 15, embodied on a carrier medium.
